(19) United States
(12) Patent Application Publication
(10) Pub. No.: US 2015/0233435 A1
(43) Pub. Date: Aug. 20, 2015

(54) INTEGRATED SLACK ADJUSTER WITH IMPROVED ENVIRONMENTAL PROTECTION

(71) Applicant: NEW YORK AIR BRAKE LLC, WATERTOWN, NY (US)

(72) Inventors: Howard HUBER, JR., Black River, NY (US); Eric C. WRIGHT, Evans Mills, NY (US); Jeff SAUTER, Lowville, NY (US)

(21) Appl. No.: 14/180,903

(22) Filed: Feb. 14, 2014

(51) Int. Cl. F16D 65/00; B61H 15/00; F16D 65/14; B61H 13/20; F16D 65/38

(52) U.S. Cl. CPC F16D 65/0025; B61H 13/20; F16D 65/38; F16D 65/14; B61H 15/0057; F16D 2121/04

(57) ABSTRACT

Embodiments of the invention provide one or more of the following features or combinations of such features to slack adjusters: rubber boots or bellows on either end of the slack adjuster to shed water away from the slack adjuster; a center vent and wasp excluder to vent any water build up in the slack adjuster clutch area; an added seal and wear ring at the slack adjuster end cap; and increased corrosion and wear protection for the rod.

### CROSS-REFERENCE TO RELATED APPLICATIONS

This application claims the benefit of U.S. Provisional Application No. 61/764,230, filed Feb. 13, 2013, which is incorporated herein by reference.

### BACKGROUND OF THE INVENTION

1. Field of the Invention

Embodiments of the present invention relate generally to slack adjusters for use with railcar brake rigging. More particularly, embodiments of the present invention are directed to integrated slack adjusters with improved environmental protection.

2. Statement of the Prior Art

On many railcars, braking forces are transmitted from a brake cylinder to the brake shoes by a system of rods and levers called brake rigging. The three basic types of brake rigging for railcars are body-mounted brakes, truck-mounted brakes, and direct-acting cylinders. Body-mounted brake systems typically have one brake cylinder, mounted underneath the body of the railcar, which transmits braking forces to the brake shoes through a system of rods and levers. Truck-mounted brake systems, in contrast, typically have multiple brake cylinders mounted on each truck. Such systems transmit braking forces through a less complicated system of rods and levers than with body-mounted brake systems. Because of the additional brake cylinders, such systems also feature smaller diameter brake cylinders and lower lever ratios. Direct-acting brake cylinders are a form of truck-mounted brakes, which use brake beams that are connected directly to the brake pistons.

Most modern railcars have brake cylinders equipped with slack adjusters. Such slack adjusters automatically compensate for the wear induced in the brake blocks or pads during braking. They usually operate with some form of ratchet system fitted internally or as part of the brake cylinder assembly.

Slack adjusters are most commonly located in the center rod as shown in FIG. 3 of conventional, so-called “foundation” brake rigging. They are typically installed with reference to the applicable installation drawing (e.g., U.S. Pat. No. 784,600 of New York Air Brake LLC, which is incorporated herein by reference) and the appropriate AAR standards for Group E Slack Adjusters (e.g., S-400, S-420, S-421, S-422, each of which is incorporated herein by reference).

Further details regarding the installation and maintenance of such slack adjusters may be found in the following publications of New York Air Brake LLC: “Slack Adjuster Installation & Maintenance Guide For Model KRD-482-E P/N 783901,” IP-241, Issue No. 3 (Jul. 9, 2010), and “Repair Track Maintenance Of DB-60 Type Freight Brake Equipment,” IP-175, Issue No. 5 (Aug. 11, 2010), each of which is incorporated herein by reference.

Slack adjusters according to the prior art generally do not require any special maintenance or servicing. Maintenance typically consists of checking for proper piston stroke and visual inspections for damage or malfunctions during normal car servicing. However, prior art slack adjusters suffer from the disadvantage that they are prone to environmental damage such as by dust, dirt, and corrosion.

Accordingly, it is an object of embodiments of the invention to provide a slack adjuster with improved environmental protection against elements such as dust, dirt, and corrosion.

### BRIEF DESCRIPTION OF THE DRAWINGS

The object and advantage of the embodiments of the invention will become more readily apparent to those of ordinary skill in the art after reviewing the following detailed description and accompanying documents wherein:

FIG. 1 illustrates a typical slack adjuster according to the prior art;

FIG. 2 is an exploded view of the prior art slack adjuster shown in FIG. 1;

FIG. 3 illustrates a typical center rod installation of the prior art slack adjuster shown in FIGS. 1 and 2;

FIG. 4 illustrates a slack adjuster according to one embodiment of the invention;

FIG. 5 illustrates a slack adjuster according to another embodiment of the invention;

FIG. 6 illustrates in greater detail the rod end cap or boot and boot opening according to embodiments of the invention;

FIG. 7 illustrates a cross-sectional view of the rod end cap or boot and boot opening shown in FIG. 6;

FIG. 8 illustrates an orthogonal view of the rod end cap or boot shown in FIG. 6;

FIG. 9 illustrates a cross-sectional view of the vent anti-rotation plug and vent opening according to embodiments of the invention;

FIGS. 10A and 10B illustrate further details of the vent anti-rotation and vent opening shown in FIG. 9;

FIG. 11 illustrates an orthogonal cross-sectional view of an alternate rod end cap or boot;

FIG. 12 illustrates further details of the alternate rod end cap or boot shown in FIG. 11; and

FIG. 13 illustrates further details of embodiments of the invention and, in particular, a bellows boot.

### DETAILED DESCRIPTION OF EXEMPLARY EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. Persons of ordinary skill in the relevant art will recognize that other components and configurations may be used without departing from the true spirit and scope of the embodiments. It is to be understood that each specific element includes all technical equivalents that operate in a similar manner to accomplish a similar purpose. The examples and embodiments described herein are non-limiting examples.

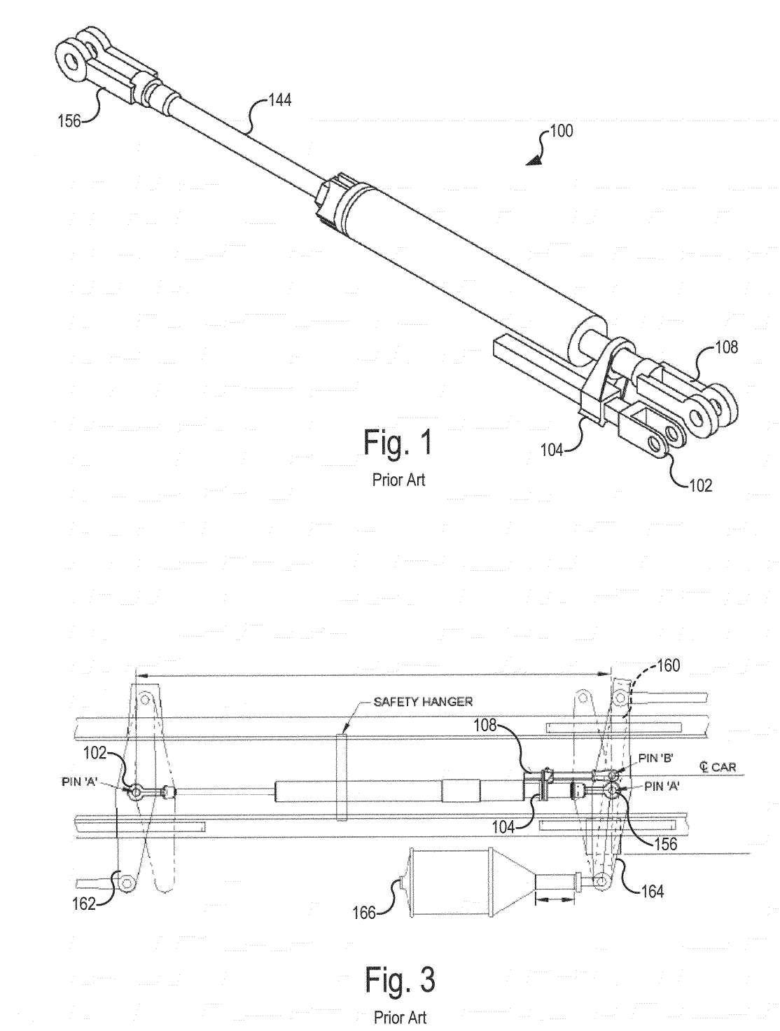

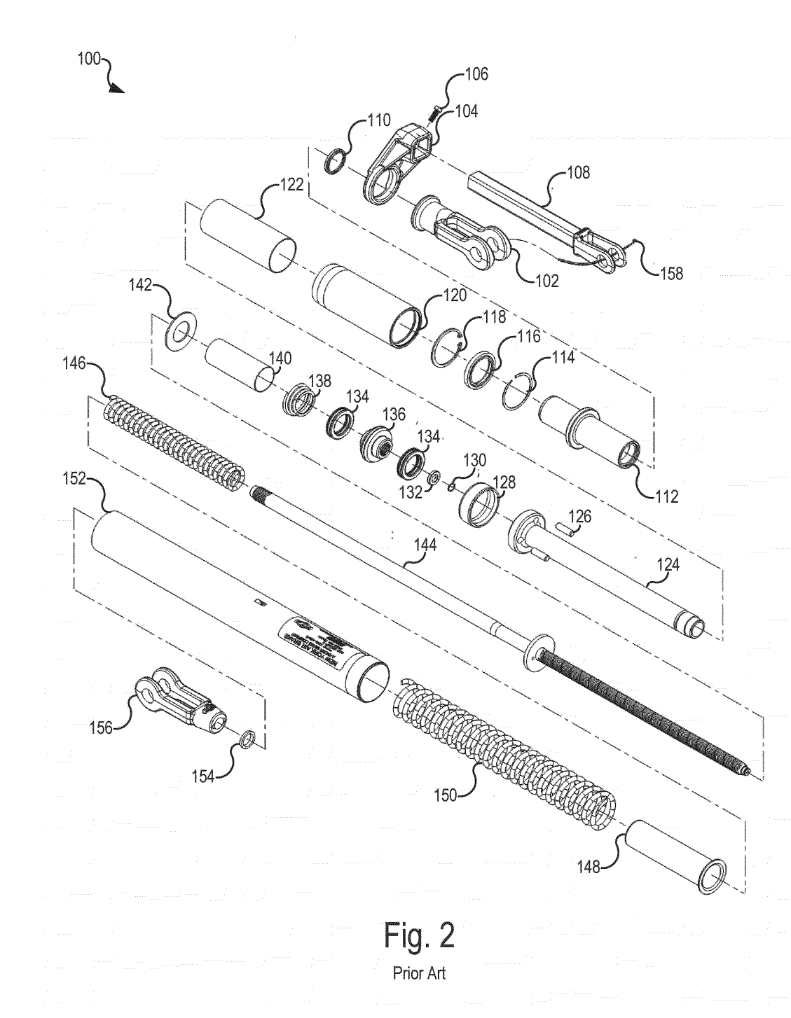

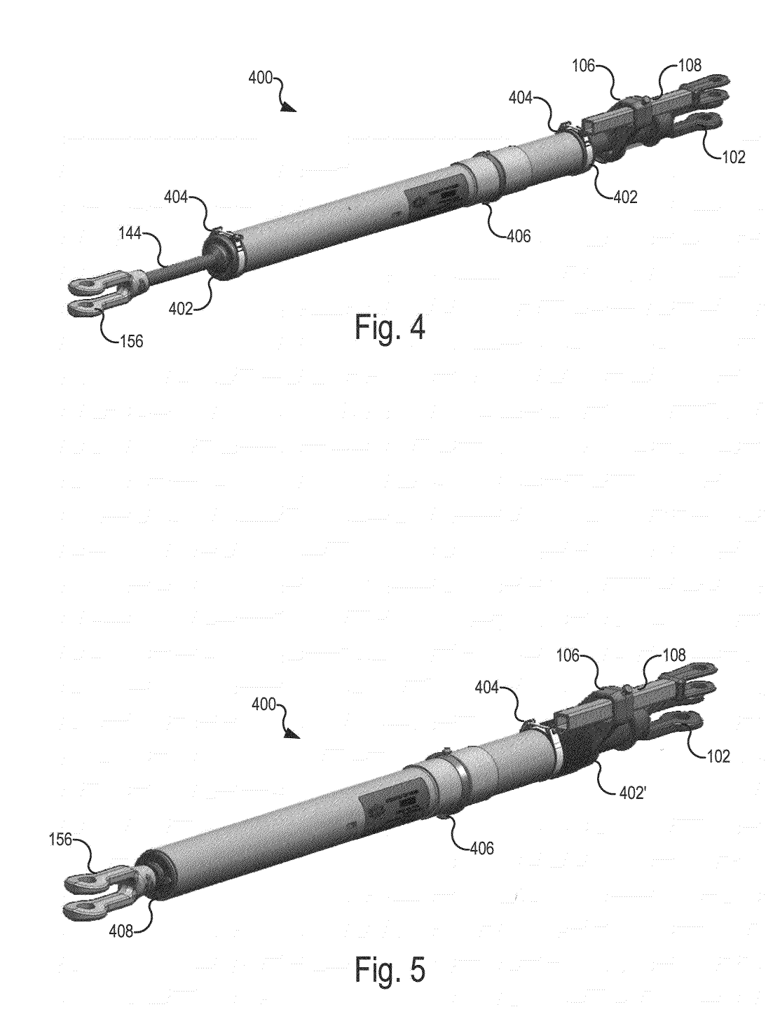

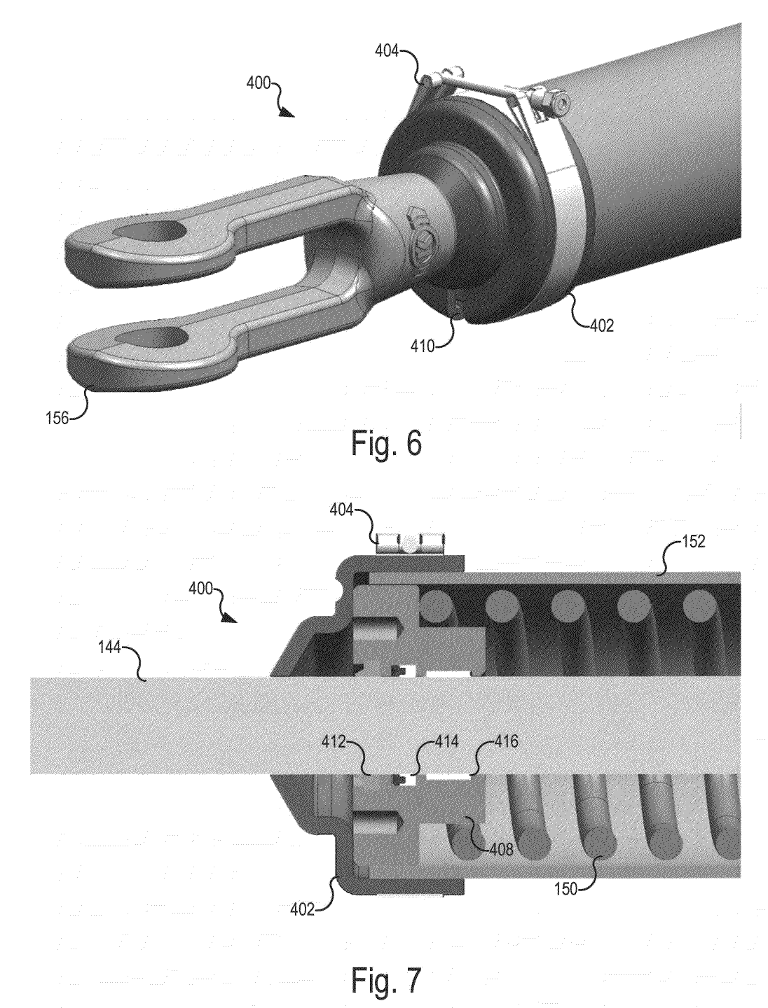

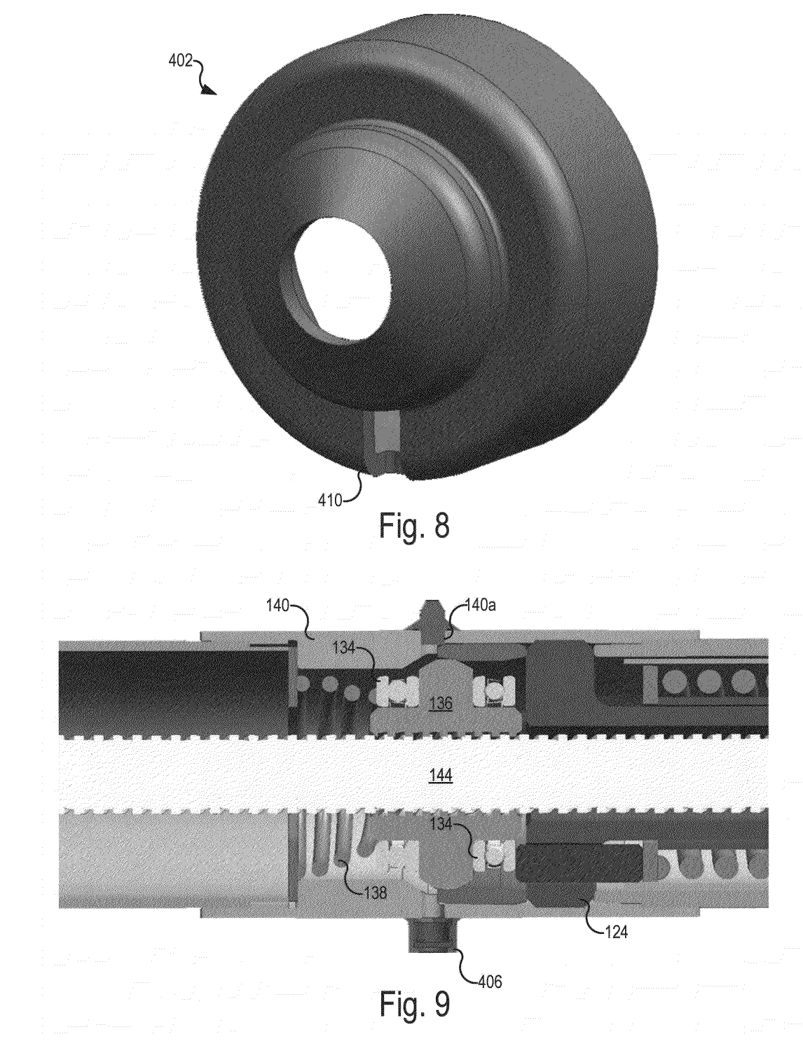

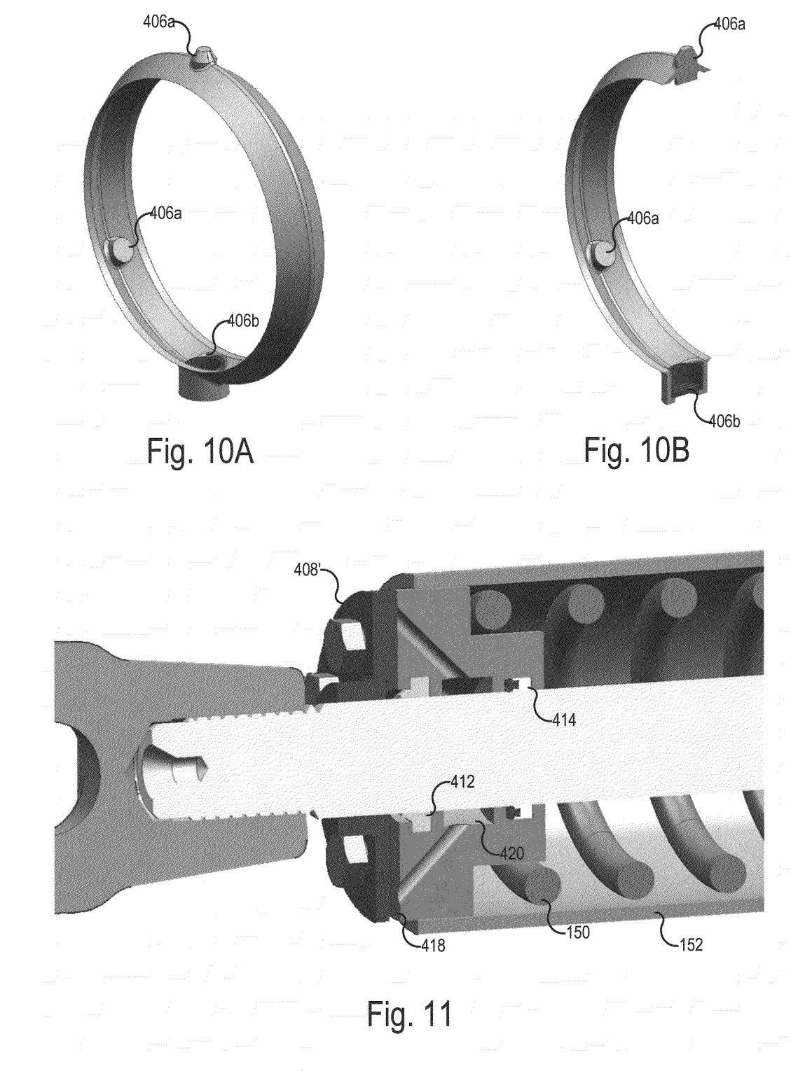

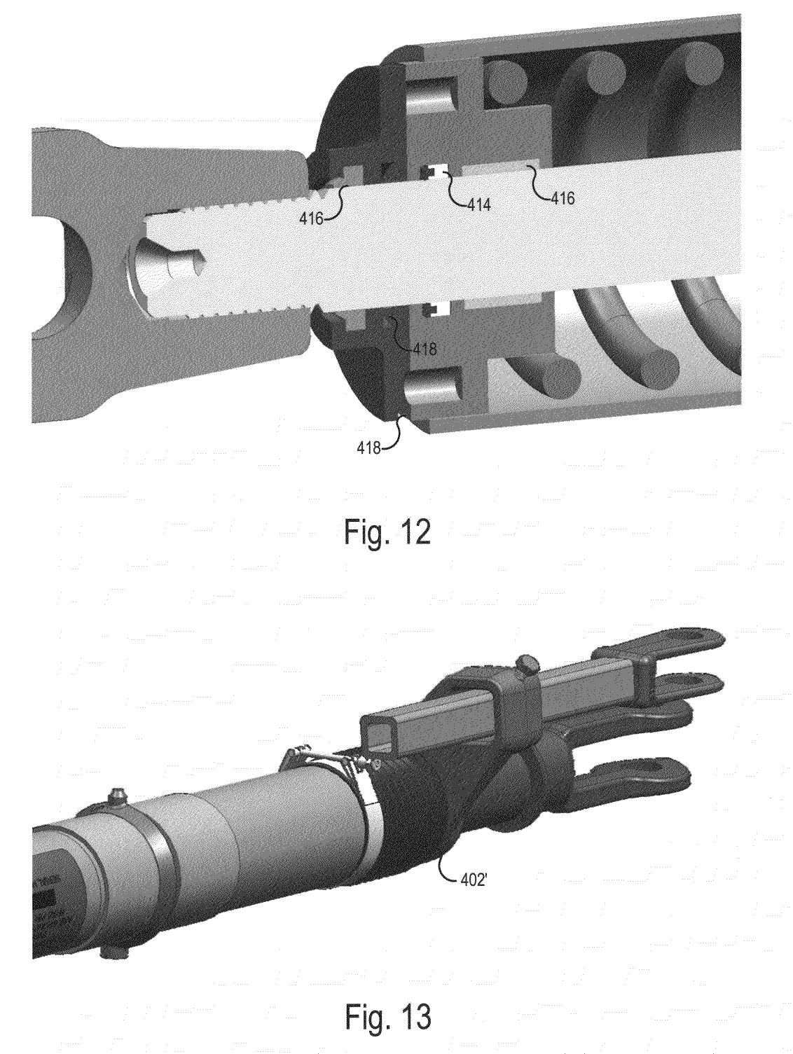

Referring now to the drawings, wherein like reference numerals and characters represent like or corresponding parts throughout each of the views, there is shown in FIGS. 1-3 a slack adjuster 100 according to the prior art. Slack adjuster 100 generally comprises a front clevis 102, an actuating collar 104 which may be held in place by a hex head cap screw 106, a control rod assembly 108, and a wiper ring 110. It further comprises an actuating tube 112, an internal retaining ring 114, a wiper ring 116, a retaining ring 118, an overtravel housing 120, and an overtravel assembly 122. Slack adjuster 100 still further comprises a rod guide 124, a trigger pin 126, a front clutch 128, a retaining ring 130, a safety washer 132 between a pair of thrust bearings 134, a clutch 136, a conical compression spring 138, a body coupling 140, and a clutch spring seat 142. Finally, it comprises a tension rod assembly 144, a compression spring 146, a spring guide 148, another, larger compression spring 150, a spring housing assembly 152, a wiper 154, a rear clevis 156, and a cable tie 158.

As shown in FIG. 3, the control rod 108 of slack adjuster 100 is coupled to the control lever 160 on the brake rigging. Front clevis 102 is adapted to be coupled to the fulcrum lever 162 on the brake rigging. Rear clevis 156 is likewise adapted to be coupled to the cylinder lever 164 of the brake rigging using an AAR Type “A” pin (i.e., 1 7/32″ dia.×3½ ″ long). The length of the slack adjuster 100 may be adjusted as required by turning the adjuster spindle using the front clevis 102, so that the hole in the front clevis 102 lines up with the hole in the fulcrum lever of the brake rigging. Once a proper length is acquired, the front clevis 102 may be attached to the fulcrum lever 162 of the brake rigging using another AAR Type “A” pin (i.e., 1 7/32″ dia.×3½″ long). The control lever 160 must conform to the requirements of AAR standard S-420, S-421, and S-422, and is adapted to be coupled to the clevis of the control rod 108 using an AAR Type “B” pin (i.e., 1 3/32″ dia.×2 2/2″ long).

Embodiments of the invention provide one or more of the following features or combinations of such features to slack adjusters: rubber boots 402 or bellows 402′ at either end of the slack adjuster 100′ to shed water away from the slack adjuster 100′; a center vent 406 and wasp excluder 406b to vent any water build up in the slack adjuster 100′ clutch area; an added seal 414 and wear ring 416 at the slack adjuster end cap 408; and increased corrosion and wear protection for the control rod 108.

While the slack adjuster as shown and described herein may be adapted for use in body-mounted brake systems, its environmental improvements may be used in truck-mounted brake systems as well.

Although the present invention has been described and illustrated in detail, it is to be clearly understood that the same is by way of illustration and example only, and is not to be taken by way of limitation. The spirit and scope of the present invention are to be limited only by the terms of the appended claims.

1. An integral brake actuator-slack adjuster unit, comprising:
a housing to be mounted on a brake beam or truck;
a piston sliding in a cylinder on said housing, said piston having a brake released position and a brake applied position;
a first portion of the cylinder being removable from the housing;
a rod connected to said piston and slidably received in a bore in said housing;
an aperture in said housing intersecting said bore; and
a sealing member interconnected to said housing to form a water tight seal therearound.

2. An integral brake actuator-slack adjuster unit, comprising:
a housing to be mounted on a brake beam or truck;
a piston sliding in a cylinder on said housing, said piston having a brake released position and a brake applied position;
a first portion of the cylinder being removable from the housing;
a rod connected to said piston and slidably received in a bore in said housing; an aperture in said housing intersecting said bore; and
a center vent and wasp excluder in communication with a clutch area of the slack adjuster so that any water will vent out of said clutch area.

3-5. (canceled)

6. The slack adjuster according to claim 1, wherein the slack adjuster is adapted for use in a body-mounted brake rigging.

7. The slack adjuster according to claim 1, wherein the slack adjuster is adapted for use in a truck-mounted brake rigging.

8. The slack adjuster of claim 1, wherein the sealing member comprises a boot affixed over one end of said housing and having a hole formed therethrough for said rod to slidingly move therethrough.

9. The slack adjuster of claim 1, wherein the sealing member comprises a bellows affixed over one end of said housing.

10. The slack adjuster of claim 1, wherein said sealing member comprises a sealing ring positioned within said housing and in engagement with said housing and said rod to provide a water tight seal therebetween.

11. The slack adjuster of claim 10, wherein said sealing member further comprises a wear ring positioned proximately to said sealing ring within said housing and in engagement with said housing and said rod to provide a water tight seal therebetween
